(19) United States
(12) Patent Application Publication
(10) Pub. No.: US 2026/0080355 A1
(43) Pub. Date: Mar. 19, 2026

(54) Artificial Intelligence Agent Using a Machine-Learning Model and Reinforcement Learning Model to Guide Picking Process

(71) Applicant: Maplebear Inc., San Francisco, CA (US)

(72) Inventors: Naval Shah, Toronto (CA); Luis Manrique, Joshua Tree, CA (US)

(21) Appl. No.: 19/098,767

(22) Filed: Apr. 2, 2025

Related U.S. Application Data
(60) Provisional application No. 63/695,829, filed on Sep. 17, 2024.

(51) Int. Cl. G06Q 10/087; G06N 20/00

(52) U.S. Cl. CPC G06Q 10/087; G06N 20/00

(57) ABSTRACT

An artificial intelligence (AI) agent is disclosed that assists an entity to complete a task. The entity is assigned to complete a task. The AI agent monitors events to detect an occurrence of an event associated with the task. A machine learning model of the AI agent is prompted to generate a set of candidate actions based in part on the detected event and data about the entity. A reinforcement learning model of the AI agent scores each candidate action from the set to tailor the candidate actions to the entity. A scored action is selected as a recommended response to the event and is communicated to a client device of the entity which causes the entity to perform the selected action.

### CROSS-REFERENCE TO RELATED APPLICATION

This application claims the benefit of U.S. Provisional Patent Application Ser. No. 63/695,829, filed on Sep. 17, 2024, which is incorporated by reference herein in its entirety.

### BACKGROUND

Conventional online systems receive task requests from users where the tasks are completed by entities on behalf of the users. Occasionally, the entities may require assistance to complete the tasks. Conventional online systems employ discrete machine learning models that each assist the entity in a specific situation that is unique to the model. However, these conventional systems cannot assist an entity during the entire duration during which the entity completes the task since the entity may encounter a multitude of different situations that the discrete machine learning models are not configured to handle. Furthermore, the usage of multiple discrete machine learning models to assist the entities requires more resources, such as processing power and memory, which is inefficient.

### SUMMARY

In accordance with one or more embodiments of the disclosure, an artificial intelligence (AI) agent is disclosed that assists or coaches entities to complete a task. An entity is assigned to complete a task at a source by an online system on behalf of a user. The AI agent monitors events to detect an occurrence of an event from a set of predetermined events. A machine learning model of the AI agent is prompted to generate a set of candidate actions based in part on the detected event and data about the entity. A reinforcement learning model of the AI agent scores each candidate action from the set. One of the scored actions is selected as a recommended response to the event and is communicated to a client device of the entity. The recommended response may cause the entity to perform the selected action.

### BRIEF DESCRIPTION OF THE DRAWINGS

FIG. 1 illustrates an example system environment for an online system, in accordance with one or more embodiments.

FIG. 2 illustrates an example system architecture for the online system, in accordance with one or more embodiments.

FIG. 3 is a diagram describing an operation of an AI agent, in accordance with one or more embodiments.

FIG. 4 is a diagram illustrating a timeline of events that occur during completion of a task during which one or more recommended actions are communicated to an entity in response to the events, in accordance with one or more embodiments.

FIG. 5 is a flowchart for a method of coaching an entity using an AI agent, in accordance with some embodiments.

### DETAILED DESCRIPTION

Embodiments of an artificial intelligence (AI) agent for coaching entities (e.g., pickers) are described herein. An entity associated with a client device may be assigned a task for completion at a source by an online system. In the description herein, an example of a task is to fulfill an order at a source such as a grocery store. However, the embodiments herein are applicable to any type of task where an entity would benefit from coaching by an AI agent to complete the task.

The AI agent monitors various types of data including entity data and source data. The AI agent may comprise a machine learning model (such as a large language model) and a reinforcement learning model, along with code that invokes and coordinates actions between the two. The machine learning model may be tuned (e.g., prompt tuning) using various types of data (e.g., the source data and the entity data).

Responsive to a determination that an event associated with the task has occurred, the machine learning model is prompted to generate a set of candidate actions (e.g., potential actions) based in part on the event and one or more inputs (e.g., source data, entity data, etc.). The reinforcement learning model scores some or all of the set of candidate actions to form a scored set of candidate actions. The machine learning model is prompted with the scored set of candidate actions to select one of the scored set of candidate actions as a recommended response to the event. The AI agent generates a recommendation for the entity based in part on the recommended response. The AI agent communicates the recommendation which causes the entity to perform the recommended action. For example, the recommendation may be displayed on the client device of the entity which causes the entity to perform the action described by the recommendation or some other action in response to the event.

In the above manner, the AI agent can coach entities in responding to different events, where the coaching is not only in real-time or near real-time, but also has potential to increase one or more performance metrics associated with the entity (e.g., increased efficiency). Moreover, further tuning of the machine learning model and/or the reinforcement learning model based in part on actions taken by an entity and their resulting effects (e.g., changes in performance metric value(s)) may, over time, further improve coaching by the AI agent.

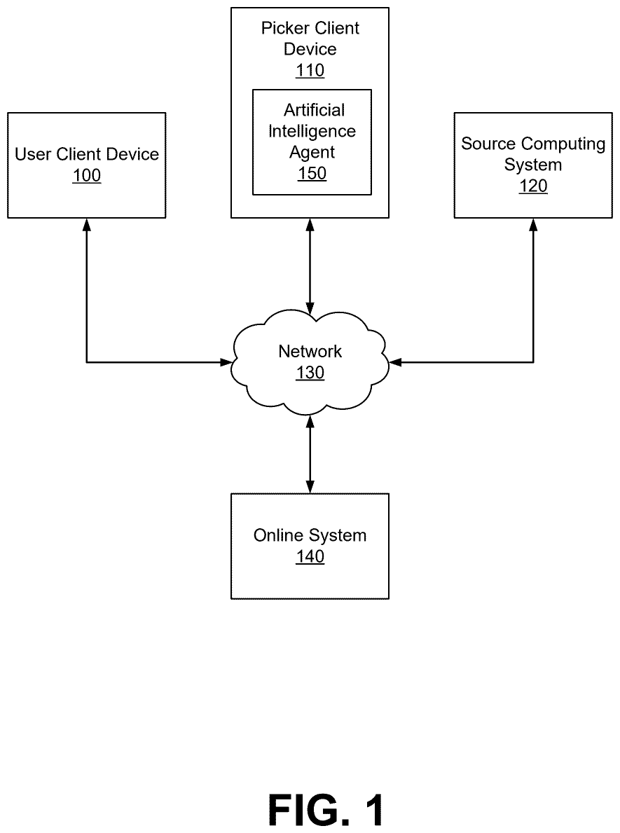

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 (i.e., an entity device) is a client device through which an entity such as a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140. The picker client device 110 may include, e.g., one or more sensors. The one or more sensors may include a location sensor, an inertial measurement unit, a microphone, a camera, etc.

The picker client device 110 receives tasks from the online system 140 for the picker (e.g., an entity) to perform on behalf of users. For example, the picker client device 110 receives orders, which is an example of a task, from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source and may even specify a sequence in which the picker should collect the items for improved efficiency in collecting items which were determined by the AI agent, as will be further described below. In some embodiments, the picker client device 110 transmits to the online system 140 or the user client device 100 which items the picker has collected in real time as the picker collects the items.

The picker client device 110 may obtain picker data associated with the picker. Picker data is information or data that describes characteristics of the picker. For example, the picker data for a picker may include the picker's name, the picker's location (e.g., within a source location, which checkout line the picker is positioned in, etc.), how often the picker has serviced orders for the online system 140, a user rating for the picker, which sources the picker has collected items at, the picker's previous shopping history, time typically spent by the picker in a source location to fulfill an order, most commonly purchased items by the picker, actions taken by the picker in response to a recommendation from an AI agent. Additionally, the picker data may include preferences expressed by the picker, such as the picker's preferred sources to collect items at, how far the picker is willing to travel to deliver items to a user, how many items the picker is willing to collect at a time, timeframes within which the picker is willing to service orders, or payment information by which the picker is to be paid for servicing orders (e.g., a bank account). The picker client device 110 may obtain picker data from sensors of the picker client device 110, from the picker's interactions with the online system 140, from the online system 140, or some combination thereof.

The picker client device 110 may obtain source data associated with the online system 140. Source data describes marketplace information associated with the online system 140. Source data may include, e.g., item data, order data, number of pickers at a source location, number of available pickers, average workload of active pickers, performance of other pickers, frequency of items at source locations being purchased, high demand item categories, fluctuations in demand for items as a function of time, demand predictions based on holidays, demand predictions based on weather forecasts, demand predictions based on societal event (e.g., health pandemic), some other marketplace information, etc. The picker client device 110 may obtain source data from, e.g., the online system 140.

Item data is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item.

Order data is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

The picker client device 110 may obtain user data associated with a user that placed the order. User data is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. The picker client device 110 may obtain the user data from, e.g., the online system 140.

The picker client device 110 uses a user artificial intelligence (AI) agent 150 to coach the picker to complete the task. By coaching the picker, the picker's efficiency is improved. The AI agent 150 is initialized on the picker client device 110 and is composed of a machine learning model and a reinforcement learning model. In some embodiments, the AI agent 150 monitors events from multiple event sources and determines an occurrence of an event of a set of predetermined events that are associated with a task that is assigned to an entity associated with a picker client device. For example, the AI agent 150 determines an occurrence of an event of a set of predetermined events that are associated with an order that is assigned to a picker.

An event may be something that may affect performance of the picker in fulfilling an assigned order. Events associated with an order assigned to a picker may include, e.g., acceptance of an order, travelling to a source, arrival at the source, entering the source, route inside of the source, obtaining an item for the order, decisions regarding substitute items, delivery location in view of items in the order, a picker obtaining a last item and being ready to checkout, checkout, receiving an update to procedures specific to a source for the order, travelling to a destination to deliver the order, arrival at destination, item data indicating that inventory for an item that is part of the order is below a threshold quantity, a number of pickers at the source for the order is above some threshold value, some other occurrence that may affect performance of the picker in fulfilling the order, etc.

In one or more example embodiments, the event may involve inventory restocking and may be communicated to the picker client device 110 by the source computing system 120. For example, when new stock arrives at a source location, the AI agent 150 can prompt the picker with updates about newly available items that were previously out of stock. Additionally, if high-demand items are restocked, the AI agent 150 can prioritize these items for pickers to reduce the likelihood of them being out of stock again quickly.

In one or more examples, the event may involve emergency situations. For example, in the event of a store evacuation, the AI agent 150 can guide the picker to the nearest exits and provide real-time updates on the emergency situation. Additionally, during emergencies such as natural disasters, the AI agent 150 can recommend the safest actions for the picker, including pausing order fulfillment if necessary.

In one or more embodiments, the event may involve customer-specific requests and may be communicated to the picker client device 110 from the user client device 100 or the online system 140. For example, if a customer makes changes to their order while the picker is fulfilling it, the AI agent 150 can prompt the picker with the updated list of items and any changes in priorities. Additionally, for orders that require special handling (e.g., fragile items, specific packaging requests), the AI agent 150 can guide the picker on how to handle these items.

In one or more examples, the event may involve operational efficiency improvements. For example, the AI agent 150 can suggest batch picking strategies for multiple orders to optimize efficiency, reducing the total time spent in the store. Additionally, if a picker's equipment (e.g., barcode scanner, smart cart, etc.) needs maintenance, the AI agent 150 can notify the picker to prevent downtime.

In one or more embodiments, the event may involve traffic and congestion updates. For example, the AI agent 150 can provide updates on the congestion levels within different areas of the store and suggest less crowded routes or times for picking. Additionally, based on real-time data, the AI agent 150 can suggest the fastest checkout lines to minimize waiting time.

In one or more arrangements, the event may involve weather-related adjustments. For example, for outdoor pickers or delivery drivers, the AI agent 150 can provide weather forecast alerts and suggest optimal times for picking and delivery. Additionally, the AI agent 150 can anticipate changes in demand due to weather conditions (e.g., increased demand for certain items during storms) and adjust picking priorities accordingly.

In one or more embodiments, the event may involve high-value order handling. For example, the AI agent 150 can be trained to ensure that high-value orders are picked, packed, and delivered with priority and provide real-time tracking updates to the customer.

In one or more examples, the event may involve AI-driven personalization. For example, the AI agent 150 can learn from a picker's past performance and preferences to tailor picking strategies that match their strengths and work habits. Additionally, the AI agent 150 can use customer data to personalize the order picking process, ensuring that items match the customer's preferences (e.g., selecting the freshest produce).

The machine learning model is configured to generate a set of candidate actions based in part on the event and one or more inputs. The inputs may include, e.g., source data, picker data, user data, or some combination thereof. In some embodiments, the AI agent 150 may apply a prompt to the machine learning model that instructs the machine learning model to generate a set of candidate actions based on the event, the source data, and the picker data. For example, an event may be the picker obtaining the last item of an order and being ready to checkout. The AI agent 150 may provide the event, the picker data, and the source data to the machine learning model which outputs a set of candidate actions. The set of candidate actions may include, e.g., different options for checkout (e.g., using self-checkout, using a particular check-out lane, using a smart shopping cart, etc.).

The reinforcement learning model scores some or all of the set of candidate actions to form a scored set of candidate actions. The reinforcement learning model may score each of the set of potential actions based in part on one or more performance targets (e.g., objectives). A performance target may include, e.g., reducing time to complete a task, reducing time at source, potential for increase in user satisfaction, potential for increase in picker satisfaction, potential to increase profit margins on order, reducing value (e.g., cost) of an order, etc. In some embodiments, each performance target has an associated weight. In some embodiments, the weight of at least one performance target is different from a weight of a different performance target.

The AI agent 150 may prompt the machine learning model with the scored set of candidate actions to select one of the scored set of candidate actions as a recommended response to the event. In some embodiments, the machine learning model may use, e.g., a Monte Carlo Tree Search (MCTS) algorithm to select an action with a highest score of the scored set of candidate actions.

The AI agent 150 may generate a recommendation for the entity based in part on the recommended response. Continuing with the above example, if the recommended response to the picker being ready for checkout is to use checkout lane 4, the AI agent 150 generates a corresponding recommendation (e.g., “Lane 4 may provide a fastest checkout for your order(s).)” for presentation to the picker (e.g., via a display of picker client device 110). The collection interface may present the recommendation which causes the entity to perform the recommended action. For example, the picker may proceed to Lane 4 to checkout for the order. The AI agent 150 monitors what action the picker takes in response to the event in order to retrain or tune the AI agent 150 to improve the performance of the AI agent 150.

The machine learning model and/or the reinforcement learning model may be tuned using one or more of the picker data, the source data, and the user data. Moreover, the AI agent 150 monitors the picker data, the source data, the user data, or some combination thereof, for an update. Responsive to detection of an update, the AI agent 150 may tune the machine learning model and/or the reinforcement learning model with the update.

In the above manner the AI agent 150 may perform a streamlined flow of actionable recommendations that are tailored to a specific situation of the picker. The AI agent 150 may apply data from multiple sources to offer context-aware recommendations that provide real-time or near real time guidance to the picker.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on the destination where the picker will deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may be assigned to complete the task on behalf of the user. For example, the robot may collect items in a source location for an order and an autonomous vehicle may deliver an order to a user from a source location. Thus, the recommended action sent to the client device of the robot causes the robot to automatically perform the recommended action to increase performance of task completion. That is, the task may be completed by the robot quicker and/or faster than if the robot were to perform the task without the AI agent 150 providing recommended actions in response to events.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 collects various types of data that may be used by AI agents. For example, the online system 140 may collect user data associated with its users, picker data associated with its pickers, and source data.

The online system 130 is a system through which users can request completion of tasks. For example, the online system 140 is an online system by which users can order items to be provided to them by a picker from a source. The online system 140 receives task completion requests such as orders from a user client device 100 through the network 130. The online system 140 selects an entity such as a picker to service the user's task and transmits the task to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store and the quantities of each of the groceries. The user's client device 100 transmits the user's order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140.

Note in some embodiments, the AI agent 150 is not part of the picker client device 110, and instead is part of the online system 140. In these embodiments, the online system 140 provides recommendations from the AI agent 150 to the picker client device 110 for presentation.

The online system 140 may train AI agents (specifically machine learning models and/or reinforcement learning models that make up the AI agents) used by the online system 140 and/or the picker client devices. For example, the online system 140 may train one or more AI agents (e.g., the AI agent 150). In some embodiments, the online system 140 provides the trained AI agent 150 to each picker client device, and the picker client device may tune the trained AI agent 150 to be personalized to the picker associated with that picker client device. In other embodiments (not shown), each picker has a respective AI agent 150 on the online system 140, and the AI agent 150 for a given picker is tuned to that picker.

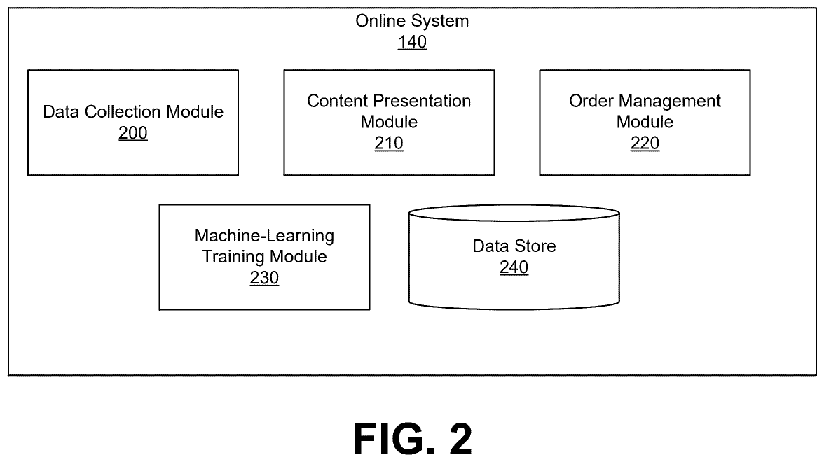

FIG. 2 illustrates an example system architecture for an online system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In one or more embodiments, the data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and order (e.g., rank) the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. As an example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives task requests such as orders from a customer client device 100 and assigns the tasks to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to assign an order to a picker based on a delivery timeframe requested by the customer with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 obtains a list of key items for an order from the key item detection module 225. When the list of ordered items are presented to the picker client device 110 for fulfillment, the order management module 220 may generate indications that the identified items are key items in the order, such that the picker presented with the items can make an increased effort and/or spend more time to fulfill the key items. In one instance, the indication is a display mechanism that emphasizes the subset of identified key items on the list via, for example, bolded text, icons next to the items, and the like. In another instance, the indication is presentation of the list of items or at least the list of key items in the relative ordering of importance when specified from the key item detection module 225. Thus, the most important item may be presented first to the picker client device 110, and then the second most important item, and so on.

In yet another instance, the order management module 220 may apply additional logic or heuristics to the one or more key items to reflect items that are more business critical than others, for example, certain items that result in higher content-related revenue for the online system 140. For example, given a subset of key items for which one is a beverage of a particular brand, and another item is a food product, the order management module 220 may present the beverage of the particular brand at a higher order (e.g., higher position) on the list responsive to determining that the beverage of the particular brand is more business critical to the online system 140 than the food item.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order and updates the customer with the location of the picker so that the customer can track the progress of their order. In some embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a user may use a user client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online system 140. For example, the machine learning module 230 may train the item selection model, the availability model, or any of the machine-learned models such as the AI agent 150. The machine learning training module 230 also trains the machine-learning model 320 and/or the reinforcement learning model 330 of the artificial intelligence agent 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data and may use databases to organize the stored data.

With respect to the machine-learned models, the machine-learned models may already be trained by a separate entity from the entity responsible for the online system 140. The machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240.

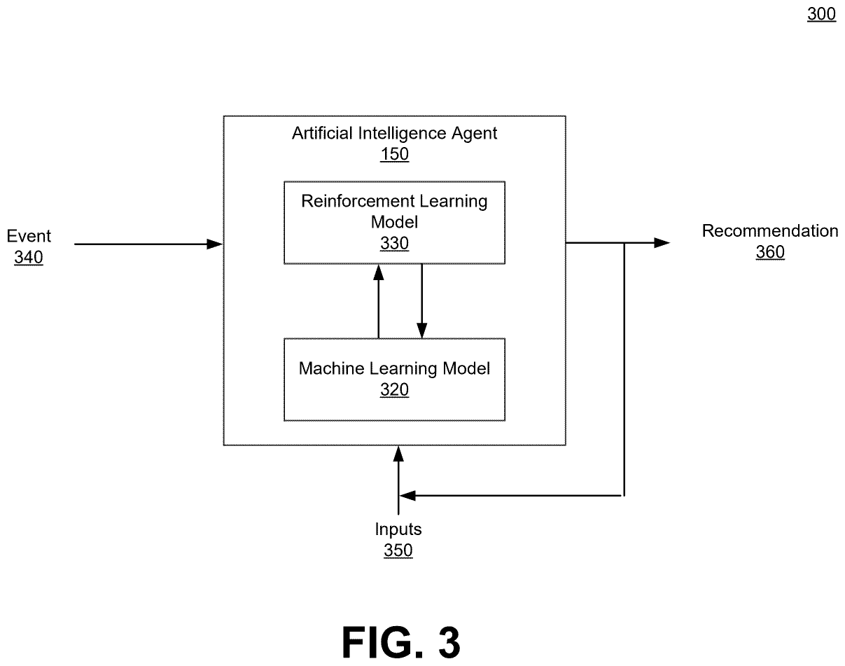

FIG. 3 is a diagram 300 describing operation of the AI agent 150 of the picker client device 110, in accordance with one or more embodiments. The AI agent 150 may include a machine learning model 320 and a reinforcement learning model 330. Some embodiments of the AI agent 150 have different components than those described here. Similarly, in some cases, functions can be distributed among the components in a different manner than is described here.

A picker associated with the picker client device 110 is assigned a task from a user such as an order. The AI agent 150 is tuned, in part, using data (e.g., picker data) associated with the picker such that the AI agent 150 is configured to generate recommendations for how to respond to various events, where the recommendations are tailored to the picker. Thus, the AI agent 150 is customized for the picker.

The AI agent 150 monitors events 340 where the events are received from one or more different event sources. For example, the AI agent 150 may receive events from the source computing system 120 as well as events from the picker client device 110. The AI agent 150 may monitor for the events once the picker has accepted the task. The AI agent 150 may be monitoring events to detect an occurrence of an event that is associated with the assigned task at hand such as the task of obtaining items for the assigned order. In some embodiments, the AI agent 150 is monitoring for events that are from a predetermined set of events for the task.

Examples of the events being monitored by the AI agent 150 for the task of obtaining items of an order include acceptance of an order, travelling to a source, arrival at the source, entering the source, route inside of the source, obtaining an item for the order, decisions regarding substitute items, delivery location in view of items in the order, a picker obtaining a last item and being ready to checkout, checkout, receiving an update to procedures specific to a source for the order, travelling to a destination to deliver the order, arrival at destination, item data indicating that inventory for an item that is part of the order is below a threshold quantity, a number of pickers at the source for the order is above some threshold value, some other occurrence that may affect performance of the picker in fulfilling the order, etc.

Responsive to occurrence of an event 340, the AI agent 150 prompts the machine learning model 320 to generate a set of potential actions based in part on the event 340 and inputs 350 (e.g., picker data, source data, user data, or some combination thereof). In some embodiments, the AI agent 150 may utilize structured prompt templates to elicit specific types of responses from the machine learning model 320. These prompt templates are engineered to include critical contextual information while maintaining a consistent structure that helps the model generate relevant candidate actions. For example, a prompt template for the checkout event may be structured as follows:
“Given the following context:
Entity profile: {picker_experience_level}, {historical_checkout_preferences}
Current task state: {items_collected}, {current_location}, {time_spent_so_far}
Source information: {checkout_lanes_available}, {self_checkout_availability}, {current_store_traffic}
Performance targets: {time_efficiency_weight}, {picker_satisfaction_weight}, {user_satisfaction_weight}
Generate a list of candidate checkout actions that the entity could take in response to being ready to checkout. For each action, provide a brief rationale addressing how it might affect time efficiency, entity satisfaction, and user satisfaction.”

This structured prompting technique allows the AI agent 150 to consistently extract relevant candidate actions from the machine learning model 320 while ensuring all pertinent contextual information is considered. The prompt templates are designed with specific sections that correspond to different aspects of the decision context, allowing the model to attend to these aspects separately before synthesizing them into candidate actions.

Different event types have tailored prompt templates optimized for the specific context of those events. For example, an item substitution event might include sections for item characteristics, user preferences, and inventory status, while a route planning event might emphasize store layout, congestion patterns, and item locations.

The AI agent 150 may dynamically modify these templates based on entity feedback and performance data. For instance, if a particular entity consistently ignores certain types of recommendations, the prompt templates may be adjusted to emphasize different factors that are more relevant to the entity's decision-making process. This adaptive prompt engineering process involves tracking the effectiveness of different prompt structures and systematically testing variations to identify optimal templates for different entity-event combinations.

The prompt templates also incorporate chain-of-thought reasoning structures that encourage the machine learning model 320 to explicitly reason through potential consequences of different actions before generating the final set of candidate actions. This approach has been shown to improve the quality and relevance of generated actions by making the reasoning process more transparent and deliberate.

In one or more embodiments, the machine learning model 320 comprises a large language model (LLM). The LLM may have a transformer-based architecture in some embodiments. The transformer architecture employs multiple self-attention layers that enable the model to weigh the importance of different parts of the input data when generating candidate actions. The machine learning model 320 may include between 6 and 24 transformer layers, with each layer containing 12 to 16 attention heads. The model may have been pre-trained on a corpus of text data that includes picking scenarios, item descriptions, source layouts, and entity-task interactions. The model may have between 500 million and 20 billion parameters, with the specific size balanced to provide accurate responses while maintaining inference speeds suitable for real-time interaction with the picker client device 110.

The architecture implements a multi-headed attention mechanism that can be formally described as:

$$Attention ( Q , K , V ) = soft max ( QK \hat{} T / √ d\_k ) V$$

where Q, K, and V are query, key, and value matrices derived from the input representations, and d_k is the dimension of the key vectors. This attention mechanism allows the model to focus on different aspects of the input context when generating candidate actions, giving particular weight to event characteristics, entity history, and source-specific constraints.

The machine learning model 320 employs rotary positional embeddings (RoPE) to enhance the model's understanding of sequential information in the events being processed. These embeddings encode relative positional information directly into the attention computation, allowing the model to better understand spatial and temporal relationships between elements in the input context. This is particularly important when processing sequences of events or navigational instructions within a source location.

To enable efficient operation on the picker client device 110, the model may utilize quantization techniques that reduce the precision of model weights from 32-bit floating point to 8-bit integers or 4-bit integers, with minimal impact on performance. Additionally, the model may implement knowledge distillation techniques whereby a smaller “student” model is trained to mimic the outputs of a larger “teacher” model, achieving comparable performance for the specific domain of picking tasks while requiring fewer computational resources.

The various data used as the inputs 350 may provide both information specific to the picker (e.g., picker's current and/or past activities, workload, language proficiency, performance metrics, etc.) as well as broader marketplace information (e.g., inventory for various items, performance insights from other pickers).

In some embodiments, the machine learning model 320 determines an event type of the received event 340. The machine learning model 320 generates a set of candidate actions that are specific to the event type of the event 340. During the duration of the performance of the task by the picker, the machine learning model 320 may generate different sets of candidate actions in response to the occurrence of each type of event where the type of actions are specific to the type of event. For example, the machine learning model 320 may receive an event that the picker is travelling to the source which is an example of a travelling event and generate a set of potential actions that are travelling type actions such as different routes to the source and a suggested departure time that is specific for each route. In another example, the machine learning model 320 may receive an event that the picker has arrived at the source which is an example of an arrival event and generate a set of candidate actions that are arrival type actions such as recommended parking locations. In some embodiments, each recommended parking location optimizes a different criterion such as reducing the time needed to find parking and/or reducing the time needed to walk to the entrance of the store.

The reinforcement learning model 330 scores each action of the set of candidate actions to form a scored set of candidate actions. The reinforcement learning model 330 may score each of the set of candidate actions based in part on one or more performance targets for the task. The performance target may include reducing time at the source, for example. For example, the reinforcement learning model 330 determines whether a duration of time for the picker to complete the task would be reduced in response to the candidate action being performed by the picker and may adjust the score based on the determination. The reinforcement learning module 330 may increase the score for the candidate action if performing the candidate action reduces the duration of time for the picker to complete the task. Conversely, the reinforcement learning module may decrease the score for the candidate action if performing the candidate action increases the duration of time for the picker to complete the task. The scoring may be based in part on how well each potential action satisfies the one or more performance objectives.

The performance targets may also include reducing a total cost of the order. For example, the reinforcement learning model 330 determines whether the total cost of the order would be reduced in response to the candidate action being performed by the picker and may adjust the score based on the determination. The reinforcement learning model 330 may increase the score for the candidate action if performing the candidate action reduces the total cost for the order due to the candidate action being a selection of a substitute item that is on sale. Conversely, the reinforcement learning model 330 may decrease the score for the candidate action if performing the candidate action increases the total cost for the order due to the candidate action being a selection of a substitute item that is more expensive than a corresponding item in the order.

In some embodiments, the reinforcement learning model 330 may also score each of the actions in an effort to increase picker satisfaction. For each recommended action, the reinforcement learning model 330 may take into account whether the picker has historically performed the action. The reinforcement learning model 330 may determine whether the picker has historically performed the candidate action during historical tasks previously completed by the picker. The reinforcement learning model 330 may adjust the score for each candidate action based on the determination. For example, the reinforcement learning model 330 may increase the score for an action if the action has been historically performed by the picker or decrease the score for the action if the picker has historically rejected (e.g., not performed) the action.

In some embodiments, the reinforcement learning model 330 may also score each of the actions in an effort to increase user satisfaction. For each recommended action, the reinforcement model 330 may take into account whether one or more users were displeased when the picker has historically performed the action. For example, the reinforcement learning model 330 may determine from user feedback that one or more other users may have been displeased with the candidate action (e.g., the picker selecting a substitute item to replace an item included in prior orders) performed by the picker during historical tasks completed by the picker. Accordingly, the score for the action may be reduced due to decreasing user satisfaction.

In some embodiments, the reinforcement learning model 330 implements a state-action-reward framework to score candidate actions. The state space is defined as a multi-dimensional vector representation that captures the entity's current context, including location within the source, task progress, time constraints, and environmental conditions. Specifically, the state representation S_t at time t can be formalized as:

$$S\_t = [ p\_t , i\_t , e\_t , c\_t ]$$

where p_t represents the entity position vector (e.g., coordinates within the source), i_t represents a task completion vector (e.g., percentage of items collected, priority items remaining), e_t represents environmental factors (e.g., store congestion levels, checkout lane wait times), and c_t represents contextual constraints (e.g., time pressure, item fragility requirements).

The action space A includes the candidate actions generated by the machine learning model 320. The reward function R(s,a) is a weighted combination of multiple objectives:

$$R ( s , a ) = w\_ 1 * RT ( s , a ) + w\_ 2 * RC ( s , a ) + w\_ 3 * RU ( s , a ) + w\_ 4 * RP ( s , a )$$

where RT represents time efficiency rewards, RC represents cost efficiency rewards, RU represents user satisfaction rewards, RP represents picker satisfaction rewards, and w_1 through w_4 are weights that may be dynamically adjusted based on task priorities.

The reinforcement learning model 330 utilizes a combination of deep Q-learning and policy gradient methods to learn optimal action-selection strategies over time. The Q-function is approximated using a neural network with 3-5 hidden layers, each containing 128-512 neurons with ReLU activation functions. The Q-network takes as input the state representation S_t and outputs estimated Q-values for each candidate action, where Q(s,a) represents the expected cumulative discounted reward for taking action a in state s.

To stabilize training, the model employs experience replay buffers that store historical (state, action, reward, next_state) tuples from previous task executions. For each scoring event, a mini-batch of 32-128 experiences is sampled from this buffer to update the Q-network parameters. The network is updated using a variant of the DQN loss function:

$$L ( θ ) = E [ {( r + {γmax\_a}^{′} Q ( {s}^{′} , {a}^{′} ; θ - ) - Q ( s , a ; θ ) )}^{2} ]$$

where θ represents the Q-network parameters, θ-represents parameters of a target network that updates more slowly than the primary network to improve training stability, r is the immediate reward, γ is a discount factor (typically between 0.9 and 0.99), and s′ is the next state.

To handle the continuous state space effectively, the reinforcement learning model 330 may incorporate techniques such as dueling network architectures that separate the estimation of state value and action advantage, and distributional reinforcement learning that models the distribution of possible returns rather than just the expected return. These techniques improve the model's ability to distinguish between actions that have similar expected values but different risk profiles.

The machine learning model 320 is prompted with the scored set of candidate actions to select one of the scored set of candidate actions as a recommended response to the event. In some embodiments, the AI agent 150 is self-prompting such that it generates the prompt that is provided to the machine learning model 320. In some embodiments, the machine learning model 320 may order (e.g., rank) the scored set of potential actions by their scores and select an action with a highest order (e.g., highest rank) as a recommended response to the event. In some embodiments, the machine learning model 320 uses a MCTS algorithm to select the recommended response from the scored set of potential actions.

The AI agent 150 may generate a recommendation 360 for the entity based in part on the recommended response which causes the entity to perform the recommendation. The recommendation 360 may be provided to the picker via a collection interface of the picker client device 110, for example. Note that the time between determination of the event 340 and providing the recommendation 360 may be relatively small, as such, the AI agent 150 is able to provide real-time or near real-time recommendations to the picker. Moreover, the recommendation 360 is tailored not only to the picker, but also to the context of the picker. A recommendation 360 may, e.g., provide an insight as to which are the fastest checkout lanes, which items are out of stock, specific store procedures, etc. The recommendation 360 may also help coach the picker to improve one or more aspects of their performance.

In some embodiments, the AI agent 150 may limit the recommendations sent to the entity so as not to pester the picker with too many recommendations. The AI agent 150 may provide a number of recommendations to the entity during the duration of the task that is less than a threshold and refrains from providing more recommendations once the threshold is reached, for example. In another example, the AI agent 150 may limit the number of recommendations that are transmitted to the entity during a specific window of time e.g., 1 recommendation every 5 minutes.

In some embodiments, the AI agent 150 may employ a modified Monte Carlo Tree Search (MCTS) algorithm to select the optimal action from the scored candidate set for the recommendation 360. Unlike traditional MCTS implementations that require explicit game-like environments, the AI agent's MCTS algorithm operates in a task-completion domain by constructing a probabilistic tree of possible future states that might result from each candidate action.

The MCTS implementation uses four distinct phases:
1. Selection: Starting from the root node (current state), the algorithm traverses the tree by selecting child nodes according to a selection policy that balances exploitation and exploration using an Upper Confidence Bound (UCB) formula:

$$UCB ( s , a ) = Q ( s , a ) + c * √ ( ln ( N ( s ) ) / N ( s , a ) )$$

where Q(s,a) is the estimated action value from the reinforcement learning model 330, N(s) is the total number of visits to state s, N (s,a) is the number of times action a has been taken from state s, and c is an exploration constant typically set between 0.7 and 1.4 that controls the exploitation-exploration trade-off.
2. Expansion: When a leaf node is reached (a state-action pair that has not been fully explored), the machine learning model 320 is used to predict potential next states and candidate actions for those states, expanding the tree. The expansion process generates a set of child nodes {(s′,a′)} where s′ represents a possible next state after taking action a from the current state s, and a′ represents a candidate action available in state s′. The transition probabilities P(s′|s,a) are estimated based on historical data and the current context.
3. Simulation: From each expanded node, the algorithm simulates task completion trajectories using a combination of the reinforcement learning model 330 and simplified task-completion heuristics. Each simulation continues for a depth of 3-8 future actions or until a terminal state is reached. The simulation process uses a lightweight policy π_sim (a|s) that approximates optimal behavior while being computationally efficient:

$$π\_sim ( a \vert s ) = soft max ( Q ( s , a ) / τ )$$

where τ is a temperature parameter that controls the randomness of the simulation policy (typically between 0.5 and 2.0).
4. Backpropagation: The results from the simulation are used to update value estimates throughout the traversed path in the tree. For each state-action pair (s,a) in the traversed path, the visit count and value estimate are updated:

$$N ( s , a ) ← N ( s , a ) + 1$$

$$N ( s ) ← N ( s ) + 1$$

$$Q ( s , a ) ← Q ( s , a ) + ( R - Q ( s , a ) ) / N ( s , a )$$

where R is the cumulative reward observed from the simulation.

The algorithm performs 50-200 simulations before selecting the action with the highest expected value. To make this process computationally efficient for real-time recommendations, the AI agent 150 implements several optimizations:
1. Progressive widening: Instead of expanding all possible child nodes, the algorithm limits the branching factor b(N(s)) based on the number of visits to the parent node:

$$b ( N ( s ) ) = ⌊ k * N ( s ) \hat{} α ⌋$$

where k and α are hyperparameters (typically k=1-5 and α=0.1-0.5).
2. Value function approximation: Rather than running complete simulations for every node, the algorithm uses the reinforcement learning model's value function to estimate the expected return from states that are more than d steps away from the current state.
3. Parallelization: The simulation phase is parallelized across multiple threads to increase the number of simulations that can be performed within the time budget.
4. Tree reuse: When consecutive recommendations are needed for related states, the algorithm reuses portions of the previously constructed tree rather than building a new tree from scratch.

This sophisticated MCTS approach allows the AI agent 150 to reason about sequences of actions and their long-term consequences rather than optimizing for immediate rewards only, resulting in more strategic recommendations that account for the full task context. The algorithm's ability to look ahead and consider future states enables it to make recommendations that may seem suboptimal in the short term but lead to better overall task completion performance.

Moreover, the machine learning model 320 and/or the reinforcement learning model 330 may be tuned once an update to the inputs 350 has occurred. For example, the picker may perform a particular action in response to the recommendation 360. The particular action performed may be in accordance with the recommendation 360, or it may be some other action. The particular action performed, the recommendation 360, and effect(s) on one or more performance metrics may result in a change to one or more of the inputs 350. The machine learning model 320 and/or the reinforcement learning model 330 may be further tuned based in part on the change to the one or more of the inputs 350. In this manner, the AI agent 150 may be able to refine and improve further recommendations for the picker.

For example, the AI agent 150 may receive feedback from the picker on the recommendation 360. The feedback may be explicit feedback. In some embodiments, the recommendation 360 may include a feedback mechanism through which the picker explicitly indicates an acceptance of the recommendation 360 or a rejection of the recommendation 360. The feedback mechanism may include a positive user interface element (e.g., a checkbox) to accept the recommendation 360 and a negative user interface element (e.g., a cross box) to reject the recommendation 360, for example.

In another example, the feedback received by the AI agent 150 is implicit feedback. The implicit feedback is based on whether the picker performed the recommendation 360 or did not perform the recommendation 360 without the picker explicitly indicating the acceptance or the rejection of the recommendation. The AI agent 150 may determine positive feedback in response to the picker performing the action included in the recommendation or may determine negative feedback in response to the picker refraining from performing the action included in the recommendation.

The AI agent 150 may also learn that the recommendation 360 was not useful through an experiment that is conducted across AI agents of other picker client devices. In the experiment, a holdout group of pickers who do not receive the recommendation is defined. The AI agent 150 may receive information from the other AI agents regarding whether pickers who received the recommendation performed the suggested action more frequently than pickers who were in the holdout group. The AI agent 150 may determine the recommendation 360 was helpful if there was a significant increase in the number of shoppers who performed the suggested action when recommended than shoppers who performed the action without receiving the recommendation.

The AI agent 150 continuously improves through a multi-stage training and adaptation process. Initial training of the machine learning model 320 involves fine-tuning on a dataset of successful entity-task interactions, using techniques such as prompt-tuning and low-rank adaptation (LoRA) to adapt pre-trained language model weights for the picking domain.

In the prompt-tuning approach, a small set of continuous prompt vectors P={p_1, p_2, . . . , p_k} are learned and prepended to the actual prompt inputs. These vectors are optimized while keeping the base language model weights frozen, which allows for efficient adaptation to the picking domain without modifying the entire model. Formally, if the original prompt embedding is E_prompt, the enhanced prompt becomes [P; E_prompt], where [;] represents concatenation.

For low-rank adaptation (LoRA), weight matrices W in the pre-trained model are modified by adding a low-rank update:

$${W}^{′} = W + BA$$

where B∈ [symbol] \hat{ }(d×r) and A∈ [symbol] \hat{ }(r×k) are trainable matrices with rank r much smaller than the original dimensions (typically r=4 to 16). This approach allows for efficient fine-tuning by reducing the number of trainable parameters while still adapting the model to the picking domain.

The training process optimizes a composite loss function combining next-token prediction accuracy with domain-specific objectives:

$$L\_total = λ\_ 1 * L\_prediction + λ\_ 2 * L\_relevance + λ\_ 3 * L\_diversity$$

where L_prediction is the standard language modeling cross-entropy loss, L_relevance measures how relevant the generated actions are to the given event (computed using a separately trained relevance classifier), L_diversity encourages the model to generate diverse candidate actions, and λ_1, 2_2, and λ_3 are weighting hyperparameters.

The reinforcement learning model 330 undergoes both offline training on historical entity-task interaction data and online adaptation based on real-time feedback. The offline training uses a combination of supervised learning from expert demonstrations and offline reinforcement learning techniques such as Conservative Q-Learning (CQL) to learn initial action scoring parameters. During operation, the model parameters θ are updated according to:

$$θ ← θ + α ∇ θ E [ {( Q ( s , a ; θ ) - ( r + {γmax\_a}^{′} Q ( {s}^{′} , {a}^{′} ; θ - ) ) )}^{2} ]$$

where a is the learning rate (typically between 0.0001 and 0.001), γ is a discount factor for future rewards, r is the immediate reward, s′ is the next state, and θ-represents parameters of a target network that updates more slowly than the primary network to improve training stability.

The AI agent 150 implements a technique called “contextual bandits” to balance exploration of new candidate actions with exploitation of known effective actions. This is achieved through a Thompson Sampling approach that maintains a posterior distribution over action effectiveness and samples from this distribution when selecting actions to recommend. The posterior distribution for each action a in state s is modeled as a Gaussian N(μ_a, σ²_a), where:

$$μ\_a = ( n\_a * \overline{r} \_a ) / ( n\_a + 1 )$$

$${σ}^{2} \_a = 1 / ( n\_a + 1 )$$

where n_a is the number of times action a has been taken in states similar to s, and r̅_a is the average reward received. As more feedback is collected on action outcomes, these posterior distributions are updated using Bayesian inference techniques, allowing the system to gradually shift from exploration to exploitation as confidence in action effectiveness increases.

Additionally, the AI agent 150 employs a federated learning approach to leverage experiences across multiple entities while maintaining entity-specific adaptations. Common knowledge is aggregated through secure model parameter averaging, while entity-specific adaptations are maintained through personalization layers that remain unique to each entity's instance of the AI agent. The federated averaging algorithm can be expressed as:

$$θ\_global = \sum ( n\_i / n ) * θ\_i$$

where θ_global are the global model parameters, θ_i are the parameters of the model for entity i, n_i is the number of interactions for entity i, and n is the total number of interactions across all entities.

In some embodiments, the AI agent 150 integrates with various sensors on the picker client device 110 to enhance contextual awareness and action relevance. The AI agent 150 may include a sensor integration module processes multiple data streams including:
1. Location data: GPS coordinates for outdoor positioning and Bluetooth Low Energy (BLE) beacon triangulation for indoor positioning with accuracy of 1-3 meters, allowing precise tracking of the entity's movement through the source. The location data is processed using a particle filter to reduce noise and account for sensor drift, with the state update equation:

$$\hat{x} \_t = f ( \hat{x} \_ \{ t - 1 \} , u\_t ) + w\_t$$

where \hat{x}_t is the estimated position at time t, f is a state transition function, u_t are control inputs derived from dead reckoning, and w_t is process noise modeled as a zero-mean Gaussian distribution.
2. Inertial measurement unit (IMU) data: Accelerometer, gyroscope, and magnetometer readings are fused using an Extended Kalman Filter to detect entity movements, gestures, and orientation changes with sampling rates of 20-100 Hz. The sensor fusion process can be described by the update equations:

$$\hat{x} \_t = \hat{x} \_t \hat{} - + K\_t ( z\_t - h ( \hat{x} \_t \hat{} - ) )$$

$$P\_t = ( I - K\_t H\_t ) P\_t \hat{} -$$

where \hat{x}_t is the estimated state, \hat{x}_t\hat{ }—is the predicted state, z_t are the sensor measurements, K_t is the Kalman gain, P_t is the error covariance matrix, and h is the measurement function.
3. Camera input: Visual data processing at 5-15 frames per second to recognize items, read barcodes, detect obstacles, and assess environmental conditions such as congestion or signage. The camera processing pipeline includes: image pre-processing with contrast enhancement and noise reduction, feature extraction using convolutional neural networks, object detection and classification using a lightweight YOLOv5 model optimized for mobile devices, and optical character recognition for text extraction from labels and signs.
4. Microphone input: Ambient noise level analysis and selective voice command recognition with noise cancellation techniques to enable hands-free interaction in noisy environments. The audio processing includes: spectral subtraction for background noise reduction, voice activity detection using energy thresholds and zero-crossing rates, feature extraction using Mel-frequency cepstral coefficients (MFCCs), and keyword spotting using a small-footprint neural network.

This multi-modal sensor data is preprocessed on the picker client device 110 to extract relevant features before being transmitted to the AI agent 150. The preprocessing includes dimensionality reduction, noise filtering, and feature extraction to minimize bandwidth requirements while preserving actionable information. Specifically, the dimensionality reduction is performed using a combination of principal component analysis (PCA) and autoencoders to compress the raw sensor data into a lower-dimensional representation that captures the most significant variations.

The AI agent 150 then incorporates these sensor-derived contextual features when generating and scoring candidate actions, allowing for recommendations that are responsive to the entity's physical environment and activity state. The integration follows a sensor fusion architecture where each sensor modality m contributes to a context vector c_t according to:

$$c\_t = \sum w\_m \cdot ϕ\_m ( s\_m , t )$$

where w_m is the weight assigned to modality m, φ_m is a feature extraction function for modality m, and s_m,t is the sensor data from modality m at time t.

For example, when the entity is detected to be moving quickly through an aisle (based on accelerometer and location data), the AI agent 150 may prioritize concise, time-sensitive recommendations. Conversely, when the entity is detected to be stationary in front of a shelf (based on location stability and camera input showing shelf contents), the AI agent 150 may prioritize detailed item comparison recommendations. This context-aware recommendation strategy is implemented using a decision tree that maps different sensor-derived context states to appropriate recommendation styles and content priorities.

The sensor data processing components are optimized for energy efficiency to minimize battery drain on the picker client device 110. This is achieved through techniques such as adaptive sampling rates that reduce sensor polling frequency during periods of low activity, selective activation of high-power sensors only when needed, and offloading computationally intensive processing to times when the device is charging or connected to Wi-Fi.

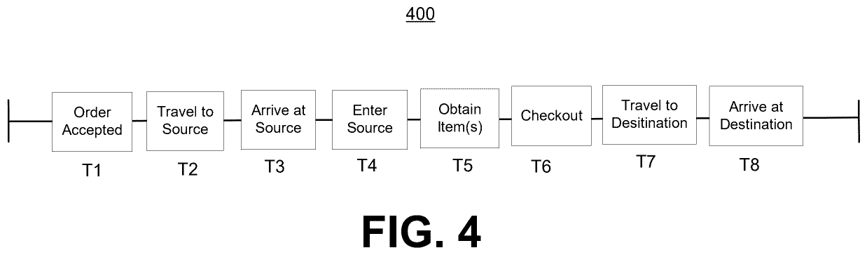

FIG. 4 is a diagram illustrating a timeline 400 of events that occur during completion of a task during which one or more recommended actions are communicated to an entity, in accordance with one or more embodiments. In the example shown in FIG. 4, the events pertain to the task of a shopper obtaining items to fulfill a user's order.

At time T1, a first event may occur where the picker accepts the task of completing an order on behalf of a user. The picker may accept the task via the picker client device 110. The AI agent 150 receives the first event and generates a first set of scored candidate actions to recommend to the picker in accordance with the first event. For example, the first set of potential actions may include different suggested routes to the source and a suggested departure time that is specific for each route.

At time T2, a second event may occur where the picker travels to the source. The AI agent 150 receives the second event and generates a second set of scored candidate actions to recommend to the picker in accordance with the second event. The second set of potential actions may include a recommendation of an alternate route than a route that was previously accepted by the picker due to traffic on the route that the picker is currently on. The second set of potential actions may include a recommended speed for the alternate route that is within the speed limit to arrive at the source in a safe and timely manner.

At time T3, a third event may occur where the picker arrives at the source. The AI agent 150 receives the third event and generates a third set of scored candidate actions to recommend to the picker in accordance with the third event. The third set of candidate actions may include a recommendation of different recommended parking locations. Each recommended parking location may optimize a different criterion. For example, a first parking location recommendation may reduce the time needed to find parking whereas a second parking location recommendation may reduce the time needed to walk to the entrance of the source.

At time T4, a fourth event may occur where the picker enters the source. For example, the picker enters the entry of a store. The AI agent 150 receives the fourth event and generates a fourth set of scored candidate actions to recommend to the picker in accordance with the fourth event. The fourth set of potential actions may include a recommendation of candidate items from the order to obtain as the first item from the order, a location in the store for each candidate item, and a route within the source from the picker's current location to the candidate item. The AI agent 150 may select the candidate items that are closest in proximity to the entry of the source, for example.

At time T5, a fifth event may occur where the picker obtains an item from the order. For example, the picker may use the picker client device 110 to indicate that the item has been obtained. The AI agent 150 receives the fifth event and generates a fifth set of scored candidate actions to recommend to the picker in accordance with the fifth event. The fifth set of candidate actions may include one or more recommendations of the next item from the order to obtain. The next item may be closest in proximity to the current location of the picker, for example. The recommendation may also include the location of the recommended next item and a route within the source to get to the location of the recommended next item. The fifth set of potential actions may also include a recommendation of a substitute item to replace an item in the order due to lack of stock of the item in the order. The fifth set of potential actions may also include a recommendation of a substitute item to replace an item in the order due to the substitute item being on sale. The fifth set of potential actions may also include a recommendation to apply a coupon for the next item.

At time T6, a sixth event may occur where the picker is ready to checkout. For example, the picker may use the picker client device 110 to indicate that the last item from the order has been obtained which signifies that the picker is ready to checkout. The AI agent 150 receives the sixth event and generates a sixth set of scored candidate actions to recommend to the picker in accordance with the sixth event. The sixth set of scored candidate actions may include one or more recommendations of different checkout lanes in the store to use to checkout, a location of each recommended checkout lane, and a recommended route to each recommended checkout lane. The recommended checkout lanes are the fastest checkout lanes in the source due to having the least amount of customers or an efficient operator of the checkout lane. The sixth set of scored candidate actions may also include a recommendation for a self-checkout option if the checkout lanes are experiencing delays due to the high volume of customers at the store.

At time T7, a seventh event may occur where the picker is travelling to the delivery destination. The AI agent 150 receives the seventh event and generates a seventh set of scored candidate actions to recommend to the picker in accordance with the seventh event. For example, the seventh set of potential actions may include different suggested routes to the delivery destination that reduce the travelling time to the delivery destination.

At time T8, an eighth event may occur where the picker arrives at the delivery destination. The AI agent 150 receives the eighth event and generates an eighth set of scored candidate actions to recommend to the picker in accordance with the eighth event. The eighth set of candidate actions may include a recommendation of different recommended parking locations at the delivery destination. Each recommended parking location may optimize a different criterion. For example, a first parking location recommendation may reduce the time needed to find parking at the delivery destination whereas a second parking location recommendation may reduce the time needed to walk to a drop off point for the order at the delivery destination. The eighth set of potential actions may also include a recommendation of whether to deliver the order in-person or to leave the order unattended at a designated location at the delivery destination.

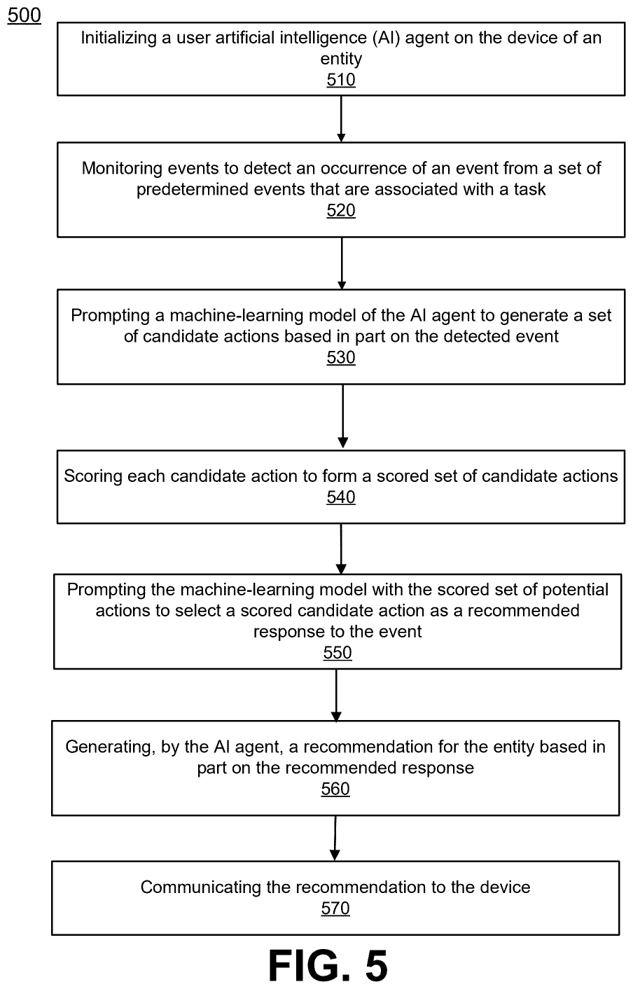

FIG. 5 is a flowchart for a method of coaching an entity using an AI agent, in accordance with some embodiments. Alternative embodiments may include more, fewer, or different steps from those illustrated in FIG. 5, and the steps may be performed in a different order from that illustrated in FIG. 5. These steps may be performed by an AI agent (e.g., the AI agent 150). The AI agent 150 may be part of the picker client device 110, the online system 140, or some combination thereof. Additionally, each of these steps may be performed automatically by the AI agent 150 without human intervention.

The AI agent 150 is initialized 510 on the device of an entity. For example, the AI agent 150 is initialized on a picker client device 110 of a picker. The AI agent monitors 520 events to detect an occurrence of an event from a set of predetermined events that are associated with a task that is assigned to the entity. An example of a task is the completion of an order by a picker on behalf of a user that submitted the order. The AI agent 150 may receive, e.g., an indication from the picker client device and/or an online system (e.g., the online system 140) that the event has occurred. In some embodiments, the AI agent 150 may monitor conditions to determine that an event, of the set of predetermined events, has occurred.

The AI agent 150 prompts 530 a machine learning model of the AI agent 150 to generate a set of candidate actions based in part on the detected event and one or more inputs. For example, the AI agent 150 may prompt the machine learning model to generate a set of candidate actions based in part on the event, source data, and picker data to tailor the set of candidate actions to the entity.

The AI agent 150 scores 540, by a reinforcement learning model of the AI agent, each action of the set of candidate actions to form a scored set of candidate actions.

The AI agent 150 prompts 550 the machine learning model with the scored set of candidate actions to select one of the scored set of candidate actions as a recommended response to the event. The machine learning model may, e.g., apply a MCTS algorithm to the scored set of candidate actions to select the recommended response to the event.

The AI agent 150 generates 560 a recommendation for the entity based in part on the recommended response. For example, if the recommended response is to take a particular route through the source to obtain items for the order, the AI agent 150 may obtain a layout of the source and overlay the particular route on the layout (and in some cases locations along the route where items in the order are located). The picker client device presents the recommendation.

The AI agent 150 communicates 570 the recommendation to the device. In some embodiments, the recommendation causes the entity to perform the action described in the recommendation. For example, a robot may automatically perform the action thereby reducing the amount of time for the robot to complete the task, thereby reducing an amount of power required by the robot to complete the task. In another example, a picker may perform the action thereby increasing the picker's efficiency to complete the task.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
initializing a user artificial intelligence (AI) agent on a device of an entity, the user AI agent comprising a machine-learned language model and a reinforcement learning model;
monitoring, by the AI agent, events from one or more event sources;
detecting, from the events, an occurrence of an event from a set of predetermined events that are associated with a task that is assigned to the entity;
prompting the machine-learned language model of the AI agent to generate a set of candidate actions based in part on the detected event, the prompt including source data about a source associated with the task and entity data about the entity;
scoring, by the reinforcement learning model of the AI agent, each candidate action of the set of candidate actions to form a scored set of candidate actions;
prompting the machine-learned language model of the AI agent with the scored set of candidate actions to select a scored candidate action from the scored set of candidate actions as a recommended response to the event;
generating, by the AI agent, a recommendation for the entity based in part on the recommended response; and
communicating the recommendation to the computer system that causes the entity to perform the selected candidate action in accordance with the recommendation.

2. The method of claim 1, wherein the one or more event sources includes the device and the source where the entity completes the task, and monitoring events from the one or more event sources comprises:
receiving, by the AI agent, events from the source; and
receiving, by the AI agent, events from the device.

3. The method of claim 1, wherein prompting the machine-learned language model of the AI agent to generate the set of candidate actions comprises:
determining an event type of the detected event;
generating, by the machine-learned language model of the AI agent, the set of candidate actions,
wherein an action type of each of the candidate actions in the set corresponds to the determined event type of the detected event.

4. The method of claim 1, wherein scoring each candidate action of the set of candidate actions comprises:
adjusting a score for each candidate action based on one or more performance targets for the task.

5. The method of claim 4, wherein adjusting the score for each candidate action comprises:
determining that a duration of time to complete the task would be reduced in response to the candidate action being performed by the entity,
wherein the score is adjusted based on the determination.

6. The method of claim 4, wherein adjusting the score for each candidate action comprises:
determining that a value associated with the task is reduced in response to the candidate action being performed by the entity,
wherein the score is adjusted based on the determination.

7. The method of claim 4, wherein adjusting the score for each candidate action comprises:
determining that the candidate action was previously performed by the entity during one or more historical tasks completed by the entity,
wherein the score is adjusted based on the determination.

8. The method of claim 4, wherein adjusting the score for each candidate action comprises:
determining from feedback of one or more users that the one or more users were displeased in response to the entity previously performing the candidate action during historical tasks completed by the entity for the one or more users,
wherein the score is adjusted based on the determination.

9. The method of claim 1, wherein selecting the scored candidate action comprises:
ordering the scored set of candidate actions; and
selecting a highest ordered candidate action from the ordered set of candidate actions as the recommended response to the event.

10. The method of claim 1, further comprising:
limiting a number of recommendations that are communicated to the device while the entity performs the task to be less than a threshold number of recommendations.

11. The method of claim 1, further comprising:
training at least one of the machine-learned language model and the reinforcement learning model of the AI agent using the entity data of the entity such that the scored set of candidate actions are tailored to the entity.

12. The method of claim 1, further comprising:
receiving feedback on the recommendation from the entity; and
performing at least one of fine-tuning of parameters of the reinforcement learning model and prompt tuning the machine-learned language model based on the received feedback.

13. The method of claim 12, wherein receiving the feedback on the recommendation comprises:
displaying a feedback mechanism on the device of the entity; and
receiving an acceptance or a rejection of the recommendation from the entity using the feedback mechanism.

14. The method of claim 12, wherein receiving the feedback on the recommendation comprises:
determining positive feedback for the recommendation in response to the entity performing the selected candidate action included in the recommendation; and
determining negative feedback for the recommendation in response to the entity refraining from performing the selected candidate action included in the recommendation.

15. The method of claim 12, wherein the entity is a robot that performs the selected candidate action.

16. A non-transitory computer readable storage medium comprising stored program code instructions, the instructions when executed causes a processing system to perform steps comprising:
initializing a user artificial intelligence (AI) agent on a device of an entity, the user AI agent comprising a machine-learned language model and a reinforcement learning model;
monitoring, by the AI agent, events from one or more event sources;
detecting, from the events, an occurrence of an event from a set of predetermined events that are associated with a task that is assigned to the entity;
prompting the machine-learned language model of the AI agent to generate a set of candidate actions based in part on the detected event, the prompt including source data about a source associated with the task and entity data about the entity;
scoring, by the reinforcement learning model of the AI agent, each candidate action of the set of candidate actions to form a scored set of candidate actions;
prompting the machine-learned language of the AI agent with the scored set of candidate actions to select a scored candidate action from the scored set of candidate actions as a recommended response to the event;
generating, by the AI agent, a recommendation for the entity based in part on the recommended response; and
communicating the recommendation to the device that causes the entity to perform the selected candidate action in accordance with the recommendation.

17. The non-transitory computer readable storage medium of claim 16, wherein the instructions that cause the processing system to prompt the machine-learned language model of the AI agent to generate the set of candidate actions comprise instructions that cause the processing system to perform steps comprising:
determining an event type of the detected event;
generating, by the machine-learned language model of the AI agent, the set of candidate actions,
wherein an action type of each of the candidate actions in the set corresponds to the determined event type of the detected event.

18. The non-transitory computer readable storage medium of claim 16, wherein the instructions that cause the processing system to score each candidate action of the set of candidate actions comprise instructions that cause the processing system to perform steps comprising:
adjusting a score for each candidate action based on one or more performance targets for the task.

19. The non-transitory computer readable storage medium of claim 16, further storing instructions that cause the processing system to perform steps comprising:
receiving feedback on the recommendation from the entity; and
performing at least one of fine-tuning of parameters of the reinforcement learning model and prompt tuning the machine-learned language model based on the received feedback.

20. A computer system comprising:
a processor; and
a non-transitory computer-readable medium storing instructions that, when executed by the processor, cause the processor to perform steps comprising:
initializing a user artificial intelligence (AI) agent on the computer system of an entity, the user AI agent comprising a machine-learned language model and a reinforcement learning model;
monitoring, by the AI agent, events from one or more event sources;
detecting, from the events, an occurrence of an event from a set of predetermined events that are associated with a task that is assigned to the entity;
prompting the machine-learned language model of the AI agent to generate a set of candidate actions based in part on the detected event, the prompt including source data about a source associated with the task and entity data about the entity;
scoring, by the reinforcement learning model of the AI agent, each candidate action of the set of candidate actions to form a scored set of candidate actions;
prompting the machine-learned language model of the AI agent with the scored set of candidate actions to select a scored candidate action from the scored set of candidate actions as a recommended response to the event;
generating, by the AI agent, a recommendation for the entity based in part on the recommended response; and
communicating the recommendation to the computer system that causes the entity to perform the selected candidate action in accordance with the recommendation.
